(19) United States
(12) Patent Application Publication
(10) Pub. No.: US 2026/0205792 A1
(43) Pub. Date: Jul. 16, 2026

(54) DETECTING AND OPERATING PROXIMATE WIRELESS DEVICES

(71) Applicant: QUALCOMM Incorporated, San Diego, CA (US)

(72) Inventors: Varun Amar REDDY, San Diego, CA (US); Le Nguyen LUONG, San Diego, CA (US); Krishna Kiran MUKKAVILLI, San Diego, CA (US); Alexandros MANOLAKOS, Athens, Attikí (GR); Joel LINSKY, San Diego, CA (US)

(21) Appl. No.: 19/135,357

(22) PCT Filed: Jan. 4, 2024
(86) PCT No.: PCT/US2024/010336

§ 371 Date: Jun. 3, 2025

(30) Foreign Application Priority Data
Mar. 3, 2023 (GR) 20230100180

(51) Int. Cl. H04W 8/00; G01S 5/02; H04L 5/00; H04W 4/02; H04W 4/80

(52) U.S. Cl. CPC H04W 8/005; G01S 5/0284; H04L 5/0048; H04W 4/023; H04W 4/80

(57) ABSTRACT

Techniques for operating a device of a group of proximate devices are disclosed. In some embodiments, such techniques may include detecting, using one or more sensors or transceivers of a first device, a presence of content playback by a second device; receiving, at the first device, one or more reference signals from the second device; responsive to the one or more reference signals containing metadata common to the first and second devices, estimating a distance to the second device using a radio frequency (RF) signal, estimating a relative angle with respect to the second device using an associated RF signal, or a combination thereof; and operating the first device in a first mode of available modes, or sending location information of the second device to a third device, based on the estimated distance, the estimated relative angle, or the combination thereof.

### RELATED APPLICATIONS

This application claims the benefit of Greek Application No. 20230100180, filed Mar. 3, 2023, entitled “DETECTING AND OPERATING PROXIMATE WIRELESS DEVICES”, which is assigned to the assignee hereof, and incorporated herein in its entirety by reference.

### BACKGROUND

### 1. Field of Disclosure

The present disclosure relates generally to the field of wireless communications, and more specifically to, e.g., enhancing operation of a User Equipment (UE) using radio frequency (RF) signals.

### 2. Description of Related Art

Short-range communications between wireless-enabled devices can allow one or more such devices to perform context-aware operations. Using current or incipient wireless communication protocols such as ultra-wideband (UWB), Bluetooth, Wireless Local Area Network (WLAN, e.g., Wi-Fi), or others based on 3GPP (Third Generation Partnership Project), a device can determine relative position with a high level of accuracy, precision, and granularity, relative to another device.

### BRIEF SUMMARY

In one aspect of the present disclosure, a method of operating a device of a group of proximate devices is discloses. In some embodiments, the method may include: detecting, using one or more sensors or transceivers of a first device, a presence of content playback by a second device; receiving, at the first device, one or more reference signals from the second device; responsive to the one or more reference signals containing metadata common to the first and second devices, estimating a distance to the second device using a radio frequency (RF) signal, estimating a relative angle with respect to the second device using an associated RF signal, or a combination thereof; and operating the first device in a first mode of a plurality of available modes, or sending location information of the second device to a third device, based on the estimated distance to the second device, the estimated relative angle with respect to the second device, or the combination thereof.

In another aspect of the present disclosure, a wireless device is disclosed. In some embodiments, the wireless device may include: one or more transceivers configured to communicate with another wireless device over ultra-wideband (UWB); memory; and one or more processors communicatively coupled to the one or more transceivers and the memory, and configured to: detect, using one or more sensors or transceivers of a first device, a presence of content playback by a second device; receive, at the first device, one or more reference signals from the second device; responsive to the one or more reference signals containing metadata common to the first and second devices, estimate a distance to the second device using a radio frequency (RF) signal, estimate a relative angle with respect to the second device using an associated RF signal, or a combination thereof; and operate the first device in a first mode of a plurality of available modes, or send location information of the second device to a third device, based on the estimated distance to the second device, the estimated relative angle with respect to the second device, or the combination thereof.

In another aspect of the present disclosure, a non-transitory computer-readable apparatus is disclosed. In some embodiments, the non-transitory computer-readable apparatus may include a storage medium, the storage medium comprising a plurality of instructions configured to, when executed by one or more processors, cause a computerized apparatus to: detect, using one or more sensors or transceivers of a first device, a presence of content playback by a second device; receive, at the first device, one or more reference signals from the second device; responsive to the one or more reference signals containing metadata common to the first and second devices, estimate a distance to the second device using a radio frequency (RF) signal, estimate a relative angle with respect to the second device using an associated RF signal, or a combination thereof; and operate the first device in a first mode of a plurality of available modes, or send location information of the second device to a third device, based on the estimated distance to the second device, the estimated relative angle with respect to the second device, or the combination thereof.

In another aspect of the present disclosure, an apparatus is disclosed. In some embodiments, the apparatus may include: means for detecting, using one or more sensors or transceivers of a first device, a presence of content playback by a second device; means for receiving, at the first device, one or more reference signals from the second device; means for, responsive to the one or more reference signals containing metadata common to the first and second devices, estimating a distance to the second device using a radio frequency (RF) signal, estimating a relative angle with respect to the second device using an associated RF signal, or a combination thereof, and means for operating the first device in a first mode of a plurality of available modes, or sending location information of the second device to a third device, based on the estimated distance to the second device, the estimated relative angle with respect to the second device, or the combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIGS. 2A and 2B are ladder diagrams illustrating devices useful for ultra-wideband (UWB) communications.

FIG. 3A is a block diagram showing components of a ranging block used in a UWB ranging session.

FIG. 3B is a block diagram showing phases of a performed with UWB with ranging slots of a ranging round of a ranging block.

FIG. 4 is a diagram showing an example of a device operation based on UWB measurements, where content from a content source may be detected at a specific side of a UE.

FIG. 5 is a diagram showing an example of a device operation based on UWB measurements, where content from a content source may be detected by one or more of multiple UEs configured for communication with one another.

FIG. 6 is a flow diagram of operating a device of a group of proximate devices, according to some embodiments.

FIG. 7 is a block diagram of an embodiment of a UE, which can be utilized in embodiments as described herein.

FIG. 8 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to wireless communications between devices. More particularly, determination of relative positions of wireless-enabled devices (e.g., UEs, IoT devices, other physical items) can include determining or estimating, for example, angle, direction, or a range or distance between a measuring device and a content source device, which can be used for certain context-aware applications at one or more of the devices that are part of the same ecosystem of devices. Some aspects more specifically related to obtaining angular and/or distance measurements via ultra-bandwidth (UWB) using a device, which may enable the device to operate or cause operations with respect to another device such as a content source in different ways depending on the direction (e.g., angle) of content and/or distance to the content source, provided that the device and the content source are determined to be part of the same ecosystem of devices. A few examples include but are not limited to (i) waking up a subsystem requiring higher power consumption may be activated based on the direction of content, (ii) unlocking or locking a door based on distance to a UE carried by a user and/or corroborating the content or type of content using other sensory modalities of the UE (e.g., image analysis and feature extraction), (iii) relaying measurements (including, e.g., direction and/or distance information) to another (third) device that can operate or cause operations. These and various other example applications will be elaborated on below.

Particular aspects of the subject matter described in this disclosure can be implemented to realize one or more of the following potential advantages. In some aspects, UWB may be used as a high-bandwidth, high-signal-strength, low-power communication protocol for short-range device-to-device (D2D) communication. UWB can provide high accuracy in determining relative positions between compatible devices that are determined to be part of the same ecosystem of devices, allowing for applications that depend on angle and/or distance between the devices. Power savings and operations that are conveniently automated may be achieved through these applications, especially given the increasing prominence of IoT devices and UEs. For example, a UE may wake up a subsystem configured to operate a backside camera only if the UE detects content generated from the back of the UE rather than the front, resulting in power savings from waking up the subsystem only when needed. As another example, a UE may control a content source device (e.g., adjust a temperature, unlock a door, display a user interface) based on a direction of the UE (e.g., “pointing” toward the content source) and corroborating with an image of the environment that the intended content source is present (as opposed to on the other side of a wall or next to another device that is not the intended content source), resulting in immediate, convenient, and sometimes automated control of another device. Warehouses, libraries, and other establishments may also leverage such context-aware applications based on similar mechanisms. Additional details will follow after an initial description of relevant systems and technologies.

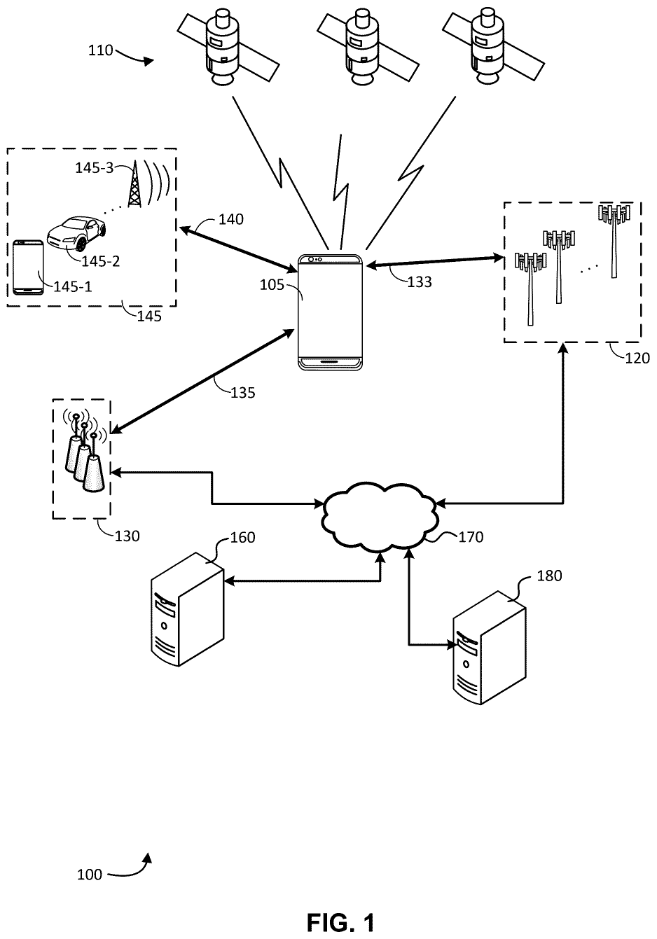

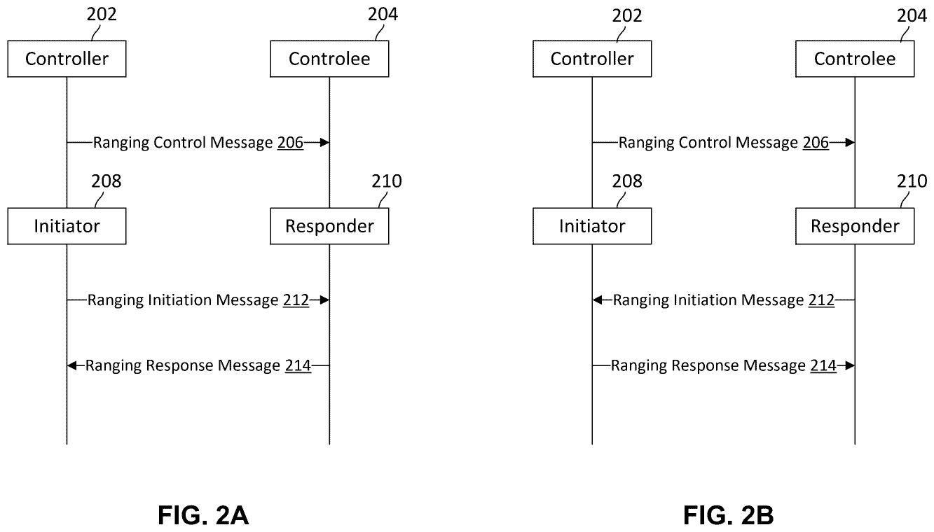

FIG. 1 is a simplified illustration of a positioning system 100 in which a UE 105, location server 160, and/or other components of the positioning system 100 can use the techniques provided herein for operating a device of a group of proximate devices, according to some embodiments. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs-e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IOT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications-e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

### Ultra-Wideband (UWB) Operations

In some embodiments, ultra-wideband (UWB) communication may be used by a wireless-enabled device such as UE 105 to communicate with proximate UEs or other devices. UWB is a wireless communications technology useful for close-range, high-throughput communication between devices in proximity, including location-based applications. UWB may be a high-bandwidth technology, with current specifications supporting a bandwidth of about 499.2 MHz or larger. UWB communications may be performed with hardware (e.g., processor, antennas and/or other components) capable of UWB. In particular, UWB may be used for transmission of information across a wide bandwidth over a short distance (e.g., 10-20 meters).

Depending on the scenario, UEs and other devices that are considered proximate may be devices within a communication range of UWB. In some cases, proximate UEs and other devices may be devices within a visibility of a user of the UE. In some cases, proximate UEs and other devices may be devices that are in the same environment (e.g., indoor or outdoor) as the UE 105. Some illustrative examples of such devices include, but are not limited to, mobile device 145, vehicles or components thereof, home devices (e.g., television, thermostat, audio speaker) or other IoT devices, containers, merchandise (e.g., located at specific locations of a warehouse or store). While the above scenarios may be useful for illustrating and describing the concepts herein, UWB and techniques described herein may be equally as effective in other scenarios not explicitly described.

A UE may have capability to detect proximity to another UE or other devices such that a user may seamlessly operate the UE or another device based on context (e.g., direction and/or distance). In some implementations, these devices may be capable of determining some level of compatibility or commonality among them. In the contexts of this disclosure, “compatible” devices in some implementations may be those having specific metadata associated with them which may communicate with one another within a “distributed context fabric” (DCF) of devices but not with other devices (e.g., devices without the specific metadata, or devices outside of a designated network or group of devices).

Examples of applications or operations between compatible devices may include powering on a device, adjusting a setting on a device, unlocking a device, responding with a selected application based on the location and/or angle of another device, etc., which may enrich the experience of the user. In other examples, one or more of the above applications may be performed if a condition between the compatible devices change, e.g., if one device become proximate to another, or if one device is no longer proximate to another

One specific illustrative example application of the above is a smartphone and earbuds that are compatible with each other by virtue of being in the same distributed context fabric, where the smartphone and the earbuds may detect proximity to each another, and a notification (e.g., a visual notification (e.g., a “push notification” on the smartphone) or an audio cue) may be offered to the user to begin audio or music playback or casting.

Another illustrative example is, when a compatible device is detected to be out of range or no longer in proximity with another compatible device, a notification or other operation may be triggered on one or more of the compatible devices. An intuitive application of this may be issuing an alert to the user that a smartphone or other device has been forgotten at home, e.g., after a smartwatch is detected to have gone out of range of the smartphone.

Another illustrative example is detecting a direction of content to be processed, and accordingly deciding to process the content with a particular module or subsystem of a compatible device, which may advantageously conserve power.

As can be seen, by detecting proximity (or lack of proximity) and/or determining directionality information, various use cases and applications can arise, as will be described in more detail below. In some implementations, UWB may be useful for these applications, as UWB is suitable for device-to-device (D2D) communications.

FIGS. 2A and 2B are ladder diagrams that illustrate communications among controller, controlee, initiator, and responder devices that are useful for UWB communications. UWB-capable devices (including devices having roles as controllers, controlees, initiators, and responders) may also be referred to as Enhanced Ranging Devices (ERDEVs). Areas of enhancement in ERDEVs include coding, preamble and modulation schemes to support improved link budget and/or reduced air time, a number of channels and operating frequencies, interference mitigation techniques to support greater device density and higher traffic use cases, improvements to accuracy, precision and reliability of ranging, discovery and connection setup mechanisms, and sensing capabilities.

Since UWB is often used with D2D protocols, it may be up to the ERDEVs to determine how to configure parameters and connect with one another. A controller is an ERDEV that controls the ranging and defines the ranging parameters by sending a Ranging Control Message (RCM). A controlee is an ERDEV that utilizes the ranging parameters received from the controller in the RCM. An initiator is an ERDEV that, following the RCM, initiates a ranging exchange by sending the first message of the exchange, the Ranging Initiation Message (RIM). A controller or a controlee can be an initiator. A responder is an ERDEV that responds to the ranging initiation message received from the initiator with a Ranging Response Message (RRM).

As shown in FIG. 2A, during an initial discovery and configuration stage, a controller 202 may send an RCM 206 to a controlee 204. The controller 202 may be a device that broadcasts a discovery message (e.g., beacon), and the controlee 204 may be a device that scans for such discovery messages. Message sent to the controlee 204 may include metadata, including, e.g., an identifier that indicates that the controller 202 is part of a specific group of devices or part of a specific ecosystem of devices (e.g., DCF). After discovery and configuration are complete, the controller 202 and controlee 204 may determine that they are part of the same ecosystem of devices (e.g., DCF).

Devices that are considered to be within the same “ecosystem of devices” may be devices that are authenticated or authorized to perform communications with (e.g., using UWB). In some cases, these devices may be part of a network, such as a home IoT network, including, e.g., a thermostat, speaker, television, light bulb, refrigerator, smartphone, smartwatch, tablet, laptop, and other smart appliances capable of wireless communication, particularly UWB communication. In some cases, these devices may be part of a designated location, such as a library or warehouse having numerous collocated items. In some cases, these devices may be associated with a user, such as a smartphone and a smartwatch that can communicate with each other for enhanced or more efficient operations. Other devices such as a door (e.g., of a room or a car) may also be associated with the user, and hence, the smartphone, smartwatch, and the car (or car door) may be part of the same ecosystem of devices, assuming each of these devices has the same metadata (e.g., identifier) that indicates such. While the above scenarios may be useful for illustrating and describing what constitutes an ecosystem of devices, myriad other associations of devices not explicitly described herein may be possible provided that there is some commonality in the identifying metadata associated with each device.

As an illustrative example, the controller 202 may be a smartphone, while a controlee 204 may be a thermostat or a vehicle. During the configuration stage, UWB may be used, or communication protocols other than UWB may be used. For instance, Bluetooth or Wireless Local Area Network (WLAN) may be used initially to set up the session between controller 202 and controlee 204 using the RCM 206. While RCM 206 can be sent and received via UWB, sending discovery and configuration information may not require high bandwidth, and thus, may be performed via Bluetooth packets to incur lower power as compared to UWB.

Once configuration is complete, the controller 202 and the controlee 204 may be designated an initiator 208 and a responder 210. After this point, the initiator 208 (e.g., smartphone) and the responder 210 (e.g., thermostat or vehicle) may exchange information via a UWB protocol, and cause or perform operations and implementations of applications such as those described above. The information may be sent and received via an RIM 212 and an RRM 214, which are the first messages of the exchange between initiator 208 and responder 210. In some instances, RIM 212 and RRM 214 may include one or more reference signals that allows determination, by the initiator 208, of range or distance, direction, and/or angle (e.g., angle of arrival (AoA) or angle of departure (AoD)) with respect to the responder 210. In some instances, the initiator 208 may operate in a specific mode (e.g., from multiple modes) based on this information (e.g., range and/or AoA). In some instances, RIM 212 may include commands to the responder 210 to, e.g., adjust the temperature or unlock the vehicle.

Depending on the scenario, RIM 212 may be sent by the initiator 208 to the responder 210, and RRM 214 sent by the responder 210 to the initiator 208, as shown in FIG. 2A; or RIM 212 may be sent by the responder 210 to the initiator 208, and RRM 214 sent by the initiator 208 to the responder 210, as shown in FIG. 2B. The initial discovery and configuration with RCM 206 between controller 202 and controlee 204 may be identical in the FIG. 2B scenario as the FIG. 2A scenario (e.g., using Bluetooth or UWB).

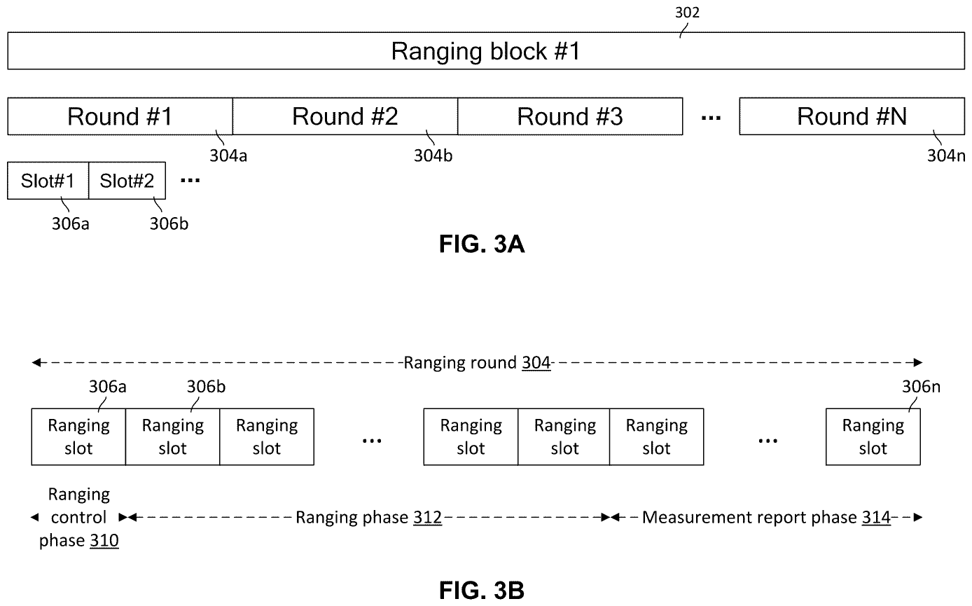

FIG. 3A illustrates a ranging block 302 and components of the ranging block 302, which may be used in a UWB ranging session for time-scheduled or contention-free ranging in UWB. A UWB session between two devices (e.g., ERDEVs) may use consecutive ranging blocks, one of which may be ranging block 302 shown in FIG. 3A. A ranging block may refer to a set of resources for ranging performed with UWB, e.g., a time frame for secure ranging. Each ranging block may include sub-portions such as ranging rounds 304a-304n, which in turn may have ranging slots 306a-306n.

Within a given ranging block 302, a responder (e.g., 210) can transmit a message only within a single round (e.g., 304a). The round index may either be statically configured by the controller or selected according to hopping pattern. As shown in FIG. 3B, the slots 306a-306n within the chosen round may be used sequentially to perform, e.g., ranging or TDOA. Each round may include a slot for a ranging control phase 310 (e.g., to determine and transmit ranging parameters such as transmission time), followed by a ranging phase 312 that may use multiple ranging slots (e.g., to send or receive RF signals with a controlee, to measure AoA with respect to the controlee, or to measure time of flight (TOF) between time of arrival and time of transmission, or angle, phase, etc. based on the RF signals), and a measurement report phase 314 that may use multiple ranging slots in which the measured TOF and AoA from the ranging phase 312 may be reported or sent within a data packet).

As discussed herein, in some embodiments, TDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., NPRS, TPRS, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “K” relative to a reference cell “Ref,” may be given as (ToAₖ-ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

### Proximity Detection Using UWB

Operating proximate devices (e.g., UE) with a compatible device within an ecosystem of devices may involve multiple steps. In some embodiments, the UE may perform discovery with another compatible device, perform ranging (e.g., determine distance and/or directionality), and operate according to the ranging.

### Discovery Process Between Compatible Devices

Devices (e.g., UE) that are compatible with a specific ecosystem of devices may determine said compatibility and/or capability (e.g., whether the devices are capable of UWB-based communication), and operate accordingly in various types of setup and discovery modes.

A first type of discovery mode is a broadcasting mode, where a wireless-enabled device may actively broadcast ranging messages, which may be on a periodic basis, semi-periodic basis, or an ad hoc basis. Examples of the ranging messages are the RCM 206 and the RIM 212. As noted above, broadcasting mode may use Bluetooth or WLAN (e.g., Wi-Fi) or other short-range D2D protocols), since UWB communication may be more power-intensive. However, UWB may be used for the broadcasting in alternative embodiments.

In some embodiments, broadcasted ranging messages may include data packets that contain metadata with identifying information that is specific to an ecosystem of devices. For example, metadata (e.g., an identifier) common to first and second devices of the ecosystem of devices may be broadcasted by the first device. In some implementations, the identifier may be a hardware-level identifier that is recognizable only to a group of compatible devices within the ecosystem of devices. In some implementations, the metadata may also include capability information about whether the devices are UWB-capable, i.e., configured to perform wireless communication with another device via UWB. Ranging parameters (e.g., transmission time) as noted above may also be included.

In some implementations, the metadata may be stored in a header or a payload of packets that form a broadcasted ranging message. In some implementations, the metadata may be placed in a preamble of the packet, or other types of frames of the packet.

In some cases, broadcasted messages may include non-ranging messages sent over bands outside of UWB (Bluetooth, WLAN, etc.) as part of the discovery process. Such non-ranging messages may contain specific instructions for the responding device, such as which communication technology to use (e.g., UWB) and when to transmit a response. Further, non-ranging messages may request the responding device to include additional information, if available, such as orientation and inertial measurement information (e.g., from an inertial measurement unit (IMU) and/or gyroscope). When such a message is detected, the responding device may transmit back a ranging message along with aforesaid additional information.

A second type of discovery mode is a scanning mode, which is more passive in nature as compared to the broadcasting mode, which is more proactive. In the scanning mode, a device may listen for broadcast ranging messages and respond when a message identifying the sending device as being part of the same ecosystem of devices (e.g., based on metadata or identifier transmitted in the message) is detected. The sending device may then determine and recognize the responding device as being part of the same ecosystem of devices.

In some cases, a controller may be in a broadcasting mode, and a controlee may be in a scanning mode. For instance, a controlee may receive an RCM 206 from a controller, where the RCM contains an identifier that indicates that the controller is part of an ecosystem of devices that the controlee is also part of.

A third type of discovery mode is a hybrid mode, which can involve one device performing either or both of the broadcasting mode or the scanning mode according to different implementations or at different times.

In UWB implementations, receiver power consumption may be greater than transmitter power consumption. Thus, broadcasting mode may be preferred by lower-power (or smaller-battery) devices such as wearable devices, IoT devices, etc. This effect of having disparate power requirements by transmitters and receivers may be more amplified with UWB compared to other technologies with a smaller bandwidth, since with higher bandwidth (e.g., over about 499.2 MHz as in the case of UWB), more power and positional performance are possible. With higher bandwidth, it is possible to, for example, estimate the time of arrival with greater precision, which can then be used to determine a range measurement. Nonetheless, transmission power with UWB remains relatively low (e.g., −14 dBm).

### Operation Based on Ranging

In some embodiments, after discovery and configuration are complete, where a device that has determined that a compatible device is part of the same ecosystem of devices, the device may determine range and directionality with respect to the compatible device.

In some implementations, distance between the devices may be determined using various approaches, such as by determining a TOF of a reference RF signal that is transmitted by an initiator device (e.g., 208) and reflected from a responder device (e.g., 210). The initiator device may determine the TOF based on a difference between the time of transmission of the reference RF signal and the time of arrival of the reflected signal. A distance between the devices may then be determined based on the TOF. In some cases, the responder device may send a reference RF signal toward to the initiator device to measure the TOF, and report the determined TOF and/or distance to the initiator (e.g., in an RRM 214).

In some implementations, a directionality with respect to the devices may be determined using various approaches, such as by determining an AoA of a reference RF signal that is transmitted by an initiator device and/or transmitted by a responder device. In some scenarios, the reference signal may be a radio signal or an optical signal (e.g., infrared signals, light emitted from the responder device). Various methodologies are available for determining the AoA, e.g., phase-based (e.g., measuring the difference in received phase across elements of an antenna array) and/or TDOA-based (e.g., measuring the TDOA between individual elements of an antenna array).

In some embodiments, based on the obtained distance and/or directionality information, various one or more operations and applications may be performed by either (or both) the initiator device or the responder device.

In some example applications, a device may operate in a selected mode from a plurality of available modes based on the direction of a nearby source of content. More specifically, consider a scenario in which a device nearby a UE is producing audio and/or video content. In some embodiments, determining the direction of the content (e.g., whether content playback is detected from the front side or the back side of the UE) can help the device determine whether to process the content using one subsystem, processor, or other component that is configured to conserve power, or to wake up another subsystem processor, or other component that is more power-intensive. For instance, a digital signaling processor (DSP) of the device may conserve more power than waking up a subsystem or an application of the device which is more power intensive.

### Example Scenarios and Applications

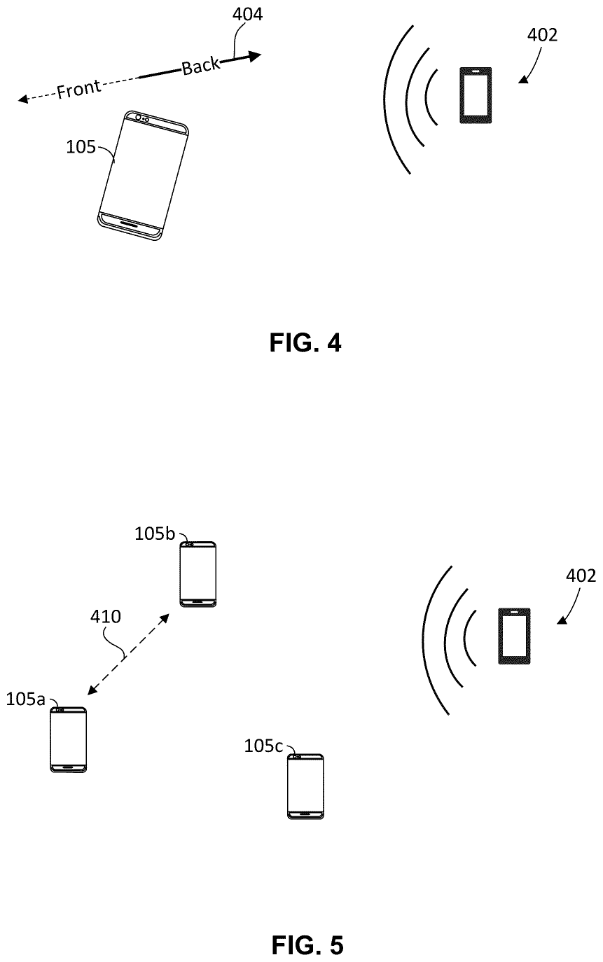

FIG. 4 illustrates an example of the above operation, where image, audio and/or video content from a content source 402 may be detected at a specific side of a UE 105. The content source 402 may be a device (including another UE) in the same ecosystem of devices as the UE 105, as determined by the discovery process discussed above (e.g., based at least on metadata exchanged during discovery). The content source 402 may be capable of generating and/or playing back content for consumption (e.g., audio, video, image), or capable of generating signals (e.g., RF signals). Each of these devices may be capable of UWB communication.

The UE may be capable of detecting the presence of content generated by the content source 402 using one or more sensors or transceivers. For example, a microphone may detect audio content; a camera may detect image or video content; a LIDAR sensor may detect light, image, or video; or a transceivers may detect RF signals.

In some implementations, the side of the UE 105 at which content is detected may be based on direction of content and orientation of the UE 105 and/or the content source 402 (e.g., based on directionality information, and/or IMU and/or gyroscope measurements of each device). For example, it may be known by the UE 105 that the UE 105 is oriented upright with the front side tilted upward (e.g., based on IMU or gyroscope), and/or that content playback is from a direction indicated by arrow 404 (e.g., based on directionality and angular (e.g., AoA) information relative to the content source 402 and/or a Light Detection and Ranging (LIDAR) detector that detects light or changes in light intensity). In some situations, the side that arrow 404 is facing may be the “back” side of the UE 105, although it will be appreciated that conventions for orientation (back, front, top, left, right, side, etc.) are arbitrary and are used for convenience and illustrative purposes. Based on orientation and direction information relative to the content source 402, the UE 105 may determine that the content may have to be processed by a backside camera (e.g., of a smartphone that may have cameras on the front and the back sides). In some implementations, the UE 105 may determine a likelihood of the content having to be processed by a particular camera (or other component) based on the orientation and direction relative to the content source 402. The UE 105 may thus prepare or initiate (e.g., wake up) a specific subsystem, component, application, or processor to process the content. In this example, the UE 105 may wake up a more power-intensive subsystem since the content is coming from the back side. In another example in which the content is determined to be coming from the front side, the UE 105 may not wake up the power-intensive subsystem and process the content using the frontside camera using a less power-intensive manner.

FIG. 5 illustrates another example of the above operation, where image, audio and/or video content from a content source 402 may be detected by one or more of multiple UEs 105a-105c configured for communication with one another. The content source 402 may be a device in the same ecosystem of devices as the UEs 105a-105c, as determined by the discovery process discussed above (e.g., based at least on metadata exchanged during discovery). Some or all of these devices may be capable of UWB. For instance, UE 105a may not be capable of UWB, but UE 105b and content source 402 may be capable of UWB. In some cases, both of the UEs 105a, 105b may be UWB-capable.

In some implementations, a first UE (e.g., UE 105a) may detect metadata (e.g., identifier common to the ecosystem of devices) from a second UE (e.g., 105b) in the vicinity which is not generating the content. Some or all of these devices may be capable of UWB. For instance, first UE 105a may not be capable of UWB measurements or may not prefer UWB (e.g., if it is a lower-power device such as a wearable), but second UE 105b may be capable of performing UWB measurements, which can be advertised in its broadcast messages (e.g., via communication link 410), e.g., to at least first UE 105a. The communication link 410 may use any type of protocol other than UWB, e.g., Bluetooth, WLAN (e.g., Wi-Fi), or another D2D protocol.

In some implementations, the first UE 105a may request the second UE 105b for information pertaining to the content source 402. In some variants, the information may include location information, directionality information, orientation information, and/or angular information. The first UE 105a may then compute the direction of the content source 402 using location information from the second UE 105b. The first UE 105a may operate in a certain mode, e.g., waking up a particular subsystem or processor (which may be cause more power-intensive applications, e.g., using a backside camera), or deciding not to wake up the particular subsystem (thereby saving power, e.g., using a frontside camera).

In other words, in the FIG. 5 scenario, the second UE 105b may perform the same determination (or portions thereof) as those that UE 105 from the FIG. 4 scenario can make, e.g., determining directionality information, orientation information, and/or angular information, etc. relative to the content source 402. However, another device (e.g., the first UE 105a) may use the information to trigger certain processing operations.

An illustrative and more intuitive example of the multiple-UE scenario such as that shown in FIG. 5 may be one involving a smartphone and a smartwatch. Consider a user equipped with a smartphone and a smartwatch. The smartphone typically has more powerful processing resources. The smartphone and the smartwatch may be determined to be (or already known to be) compatible devices. That is, the smartphone and the smartwatch may be part of the same ecosystem of devices. The smartphone and the smartwatch may be capable of UWB communications with each other. The smartphone may perform distance and/or angular (e.g., AoA) estimation with respect to a content source (e.g., audio from a television speaker) and obtain information relating to the content source. The smartphone may provide the information to the smartwatch (e.g., via communication link 410, which may be, e.g., Bluetooth or WLAN), and the smartwatch may operate in or switch to a different mode. For instance, the smartwatch may be in a low-power mode that does not require listening for audio cues. However, based on the information obtained from the smartphone, the smartwatch may selectively activate one of multiple sensors (e.g., microphones) closest to the content source. The smartwatch may not be capable of performing UWB measurements with the content source, or UWB may be deactivated, e.g., because of low power. Yet the smartwatch can still benefit from a UWB-capable device on the same ecosystem of devices using this approach and perform a context-aware application without being UWB-capable.

Additional example use cases may involve different types of devices, such as a thermostat or another smartphone. Consider an IoT device network with several nearby smart devices that are within the same ecosystem of devices. If a smartphone of the same ecosystem of devices is oriented towards such a smart device, UWB may be used to confirm the direction using AoA, as discussed above. A corresponding mode or application may then be triggered on the smartphone (e.g., a subsystem for the back camera). Alternatively, being within a certain range or distance from the smart device could trigger an action (e.g., unlocking a door or a car as the smartphone approaches and is within a certain distance threshold to the door or car, or turning a thermostat on or off as the smartphone moves away beyond a distance threshold to the thermostat). In some implementations, both the distance and angle with respect to the smart device may be needed to trigger the application.

In another pointed example use case, consider a scenario in which a smartphone is pointed toward a thermostat (e.g., a smart device capable of wireless communications with a smartphone or a wireless network, including UWB communications). Based on the angle relative to the thermostat, determined using UWB-based determination as discussed above, where the angle corresponds to a direction to the thermostat (or within a certain range of angles), the thermostat may operate accordingly. For instance, the thermostat may turn air conditioning on or off, lower the temperature, raise the temperature, cause another compatible IoT device to recite the current temperature, or other actions that will be apparent to those skilled in the relevant arts. Other use cases are possible, e.g., activating a menu, temperature dial, on/off switch, or other user interface on the smartphone when it points to the thermostat or other IoT device.

In another example use case, consider a scenario in which a smartphone is pointed toward another smartphone. This may activate one or more applications on the other smartphone, e.g., to exchange data, share content (audio, video, webpage, etc.), display information, activate a camera shutter to capture image or video (e.g., without a timer), or other actions that are preconfigured or provided by the pointing smartphone (e.g., user defined).

### Corroboration of UWB Measurements

In some embodiments, other types of measurements may be used in conjunction with previously discussed information such as location, distance, orientation, direction, and/or angle (e.g., AoA). Advantageously, the additional measurements by a UWB-capable UE may be used to confirm the intended content source device, or the presence thereof, to increase the UE's confidence level that it should perform or cause an operation or application with the content source (or another compatible device of the same ecosystem of device).

In some implementations, an image-capturing device such as a camera (e.g., at the UE or communicative with the UE) may be used to obtain image data. For example, the camera can obtain one or more images or video of at least portions of an environment. This image data can verify whether there is a device in the environment, e.g., facing the back side of the UE where the camera is. The UE may recognize certain items or devices (a television, a phone, a thermostat dial, a door, etc.) within the image data using, e.g., feature extraction. UWB measurements by the UE may corroborate the image data, or vice versa. Depth perception, range or distance, and/or direction may also be estimated using the image data, e.g., using computer vision methodologies and techniques known within the relevant arts.

As an illustrative example, if the UE has obtained directionality information (e.g., using UWB measurements) about image or video content coming from a compatible content source device, and in addition, the obtained image shows a television next to another home device (e.g., smart speaker), then the additional information acquired from image capturing validates the measurements acquired via UWB, which increases the confidence level of the UWB measurements that the content is coming from the television rather than the speaker as the intended content source. With this heightened confidence level, the UE may activate a more power-intensive subsystem to process image data from the backside camera of the UE.

As another illustrative example, if the intended source device is within a room, but the UE obtains UWB measurements with respect to another compatible device below the floor or across the wall in another room, using image data from the camera can confirm the presence of the intended content source within the room rather than another nearby content source that is not visible (yet can communicate with the UE using RF signals).

In some implementations, a light sensor (e.g., LIDAR detector) may obtain light information to corroborate the UWB measurements. Such light information may enable the UE to determine whether it is inside or outside a building, e.g., based on intensity of light or change in light intensity. Typically, a device is exposed to less light while indoor as compared to outdoor depending on the time of day (which, in some variants, may additionally be used to corroborate the light information). Using this light information, the UE may correlate the UWB measurements with the type of content may be generated from inside a building, such as a television, a smart speaker, or a thermostat. An increased confidence level of such correlation may validate whether the content is valid and from an intended content source. Light information may also enable the UE to determine other conditions, such as whether it is inside a purse or pocket of a user, whether the user has brought the device (e.g., earbuds or smartphone) up to the head, or the orientation of the device (e.g., when flipped down, increase the confidence that the backside camera or backside microphone should be activated)

In some implementations, RF sensing may be used to obtain a virtual map of the environment (e.g., indoor room). Using a map of the environment, the UE may corroborate the UWB measurements such as directionality information with the presence of a compatible device in that direction.

In some implementations, other types of signaling parameters may be used to corroborate the UWB measurements. For example, Received Signal Strength Indicator (RSSI) may be used as an indication of distance to a compatible device (e.g., responder). In some implementations, the strength of the responder's UWB message (e.g., from the content source to a smartphone UE) may be compared to an RSSI threshold. Based on this comparison, the UE may gauge whether the content source device is within proximity (e.g., the same room, building, or environment). A lower RSSI (or decreasing RSSI) may indicate that the responder is likely not in proximity or that the device may not be the intended content source, which may confirm an application with the responder, e.g., locking a door. On the other hand, a higher RSSI (or increasing RSSI) may indicate that the responder is in proximity or that the UE is approaching the responder, which may confirm an application with the responder, e.g., unlocking a locked door.

In some implementations, other types of communication protocols may be used to corroborate the UWB measurements. For example, switching to another short-range mode such as Bluetooth communication and being able to send and receive signals with the intended content source device may indicate that the content source is likely within proximity.

In some implementations, the content may be processed based on the type of content, e.g., processed only if the content and the UE are associated with the same type of content.

Consider a scenario in which a user intends to process certain content (image, audio, video, etc.) with a UWB-capable UE, particularly in an area with many content sources. According to approaches discussed herein, UWB measurements may be made between the UE and content source devices, and the UE may process the desired content based on estimated range or distance and/or estimated directional or angular information (e.g., AoA).

As an illustrative example, a user may be looking for a certain item in a dense collection of compatible items or devices in collocated region, e.g., a book in a library, a certain package on a shelf of a warehouse. A UE (e.g., smartphone, smart glasses) may guide a user to look toward to listen in a certain direction and/or from a certain distance based on the UWB measurements between the UE and the device or item (which may have a UWB-capable device attached to it). Note that the UE and these items and devices may be determined to be compatible by virtue of having the same metadata (e.g., identifier); for example, the UE may be given an active status as a library patron, which may then match with the metadata associated with the books or portions thereof. The processed content in turn can trigger applications. For instance, when a user finds an item on a shelf using UWB, and/or after processing image content that validates the intended item, more details about that item may be transmitted to the UE and/or displayed.

Here, both the content source (e.g., item or device on a shelf) and the UE processing mode may be associated with a certain content type (e.g., image, audio, video, RF sensor-based). In contrast, the content source and the UE's processing mode may be different content types. For instance, the content source may be image-based (e.g., a display screen or television) while the user's earbuds can only process audio and not images since earbuds do not have a camera. In such a case where the content types are different, the UE cannot process the intended content.

Hence, in some embodiments, information about the type of content may be included as metadata in the UWB messages between the UE and the content source. In some embodiments, the information about the type of content may be included in the preamble or payload of a UWB ranging message (e.g., RCM 206) or in the preamble or payload of a control message outside of UWB (e.g., exchanged via Bluetooth, WLAN, or other protocol).

In some embodiments, information about the type of content and/or type of device may be sent to or received from a content source. In some cases, content source may compare the information received from the UE with the content to be provided during the discovery and configuration session. In some cases, the UE may compare the information received from the content source with the content to detect with the UE during the discovery and configuration session. In some cases, the UE may compare the information received from the content source with the type of device the UE is. In some scenarios, the type of device and the type of content may be related. For example, an earbud may not be able to receive or send visual or image data, whereas a television or smartphone can. Based on the comparison, if the types do not match, or if the metadata does not identify the first and second devices as being compatible or part of the same ecosystem of devices, the discovery session may be terminated preemptively, or any ongoing range or angle estimations or operations based on such estimations (e.g., using a subsystem that is more power-intensive) may be terminated. If the types do match, then the discovery session may proceed as normal as discussed above.

### User-Device Interface

As discussed above, various types of content (image, video, audio, etc.) can be processed by a UE (e.g., smartphone). Using UWB communication (e.g., ranging and/or angle estimation), a user or the UE may detect proximity to sources of such content and perform certain operations (e.g., selectively activate a more power-intensive subsystem of the UE), receive and/or display information about the content, send commands to the content source, or be guided towards such content source, as example applications of the approaches described herein.

In some situations, UWB signaling may be used directly with a user rather than a peripheral device associated with the user, e.g., using a brain-computer interface (BCI). BCI refers to signaling that can be exchanged between a user's nervous system (e.g., picked up using electrodes) and a device that is capable of signal processing. Certain operations or signals may be triggered and applied to the user using the present disclosure.

In some example applications, UWB measurements (e.g., ranging, AoA) may be obtained via BCI. For instance, a UE (e.g., smartphone) can perform the UWB measurements and provide the measurements, including directionality and/or range information, to the user via BCI (e.g., via electrodes attached to the user). This is similar to the FIG. 5 implementation in which a more capable device (e.g., smartphone) performs the UWB measurements with a content source and relays the information to a less capable device (e.g., electrodes). In some implementations, the BCI itself may include UWB-capable hardware, e.g., UWB-capable processors or antenna array that are communicative with or embedded in the electrodes.

In some embodiments, based on these UWB measurements, the user may be guided toward certain types of content. For example, the user's eyes may be guided toward video content based on the obtained ranging and/or directionality information. Range and angle between the user (or organs such as eyes) and the content source may thereby be estimated. Knowing the current orientation of the user's head (e.g., using gyroscopic, inertial, or UWB measurements), ocular muscles or the neck may then be electrically stimulated by BCI control signals to turn the eyes toward the video content, where the BCI control signals are formed according to the obtained information. As another example, the neck may additionally or alternatively be turned toward audio content using the BCI control signals. In other implementations, BCI may be used or not used based on the type of content. For example, since RF sensor-related information cannot be processed by a human nervous system and the brain, detecting such information (e.g., in metadata in RCM or RIM) will not trigger BCI.

### Methods

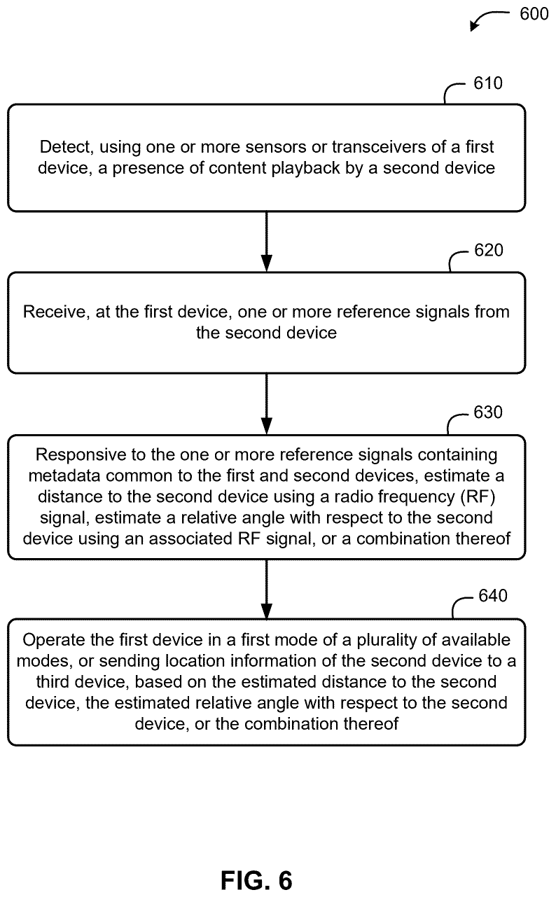

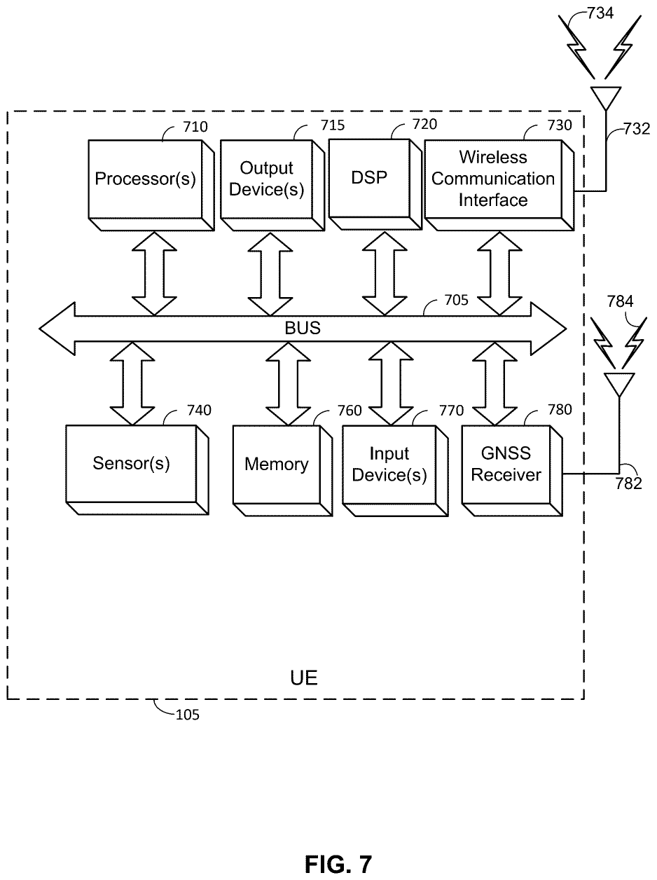

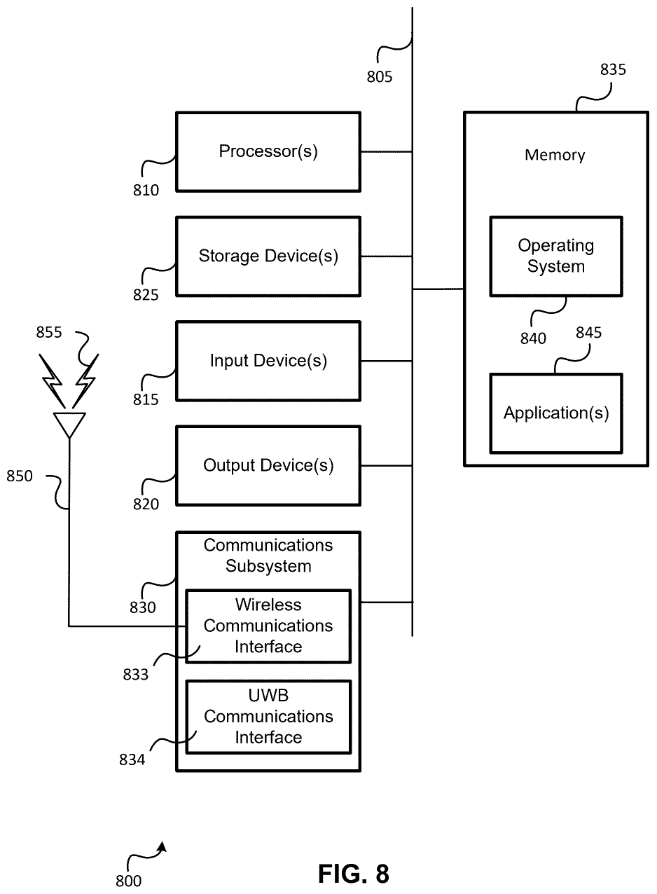

FIG. 6 is a flow diagram of a method 600 of operating a device of a group of proximate devices, according to some embodiments. Structure for performing the functionality illustrated in one or more of the blocks shown in FIG. 6 may be performed by hardware and/or software components of a computerized apparatus or system, e.g., a UE, such as a UWB-capable UE. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a UE and a computerized apparatus are illustrated in FIGS. 7 and 8, which are described in more detail below.

At block 610, the functionality comprises detecting, using one or more sensors or transceivers of a first device, a presence of content playback by a second device. In some embodiments, content may include image content, audio content, video content, radio frequency (RF) signals, or a combination thereof. In some embodiments, the first device may be a UE, and the second device may be a content source, which may be a device or a UE that is capable of generating and/or playing back content for consumption (e.g., image, video, audio), or capable of generating signals (e.g., RF signals). The UE and the content source may be capable of UWB communication. An example of the UE may be UE 105 of FIG. 4 or UE 105b of FIG. 5. An example of the content source may be content source 402 of FIGS. 4 and 5.

The one or more sensors or transceivers of the first device (e.g., UE) may be able to detect various types of content, such as auditory content using, e.g., a microphone of the UE; visual content (e.g., image or video) using, e.g., a camera of the UE; optical content or presence of light (or image or video) using, e.g., a LIDAR sensor; and/or RF signals using, e.g., a transceiver. Such types of content may be played by the source content device for consumption, or the content may simply be the presence of the source content (e.g., a door handle or lock, a book in a library, a package in a warehouse) which may be detected, e.g., visually using a camera, or virtually using RF sensing to create a virtual map of the environment.

Means for performing functionality at block 610 may include processor(s) 710, a wireless communication interface 730, comprise sensor(s) 740, and/or other components of a UE, as illustrated in FIG. 7.

At block 620, the functionality comprises receiving, at the first device, one or more reference signals from the second device. In some embodiments, the reference signals may include metadata. The metadata may include one or more identifiers or other information relating to the second device. For example, the identifier may indicate that the second device is part of a particular ecosystem of devices. In some cases, the ecosystem of devices may be the same one that the first device is part of or could be part of (e.g., once connected to a network or a local network). If the first device and the second device are part of the same ecosystem of devices (e.g., have the same identifier regarding the ecosystem of devices), they may be considered compatible devices. In some scenarios, the first and second devices may be considered to be compatible devices if those devices also have similar capabilities (e.g., can perform UWB communication for certain applications).

In some embodiments, the functionality may further include obtaining the metadata via a protocol used by the first and second devices, the protocol configured for communication via ultra-wideband (UWB), Bluetooth, or Wireless Local Area Network (WLAN), and performing, at the first device, a discovery process with the second device based on the metadata. UWB may be such a protocol.

The discovery process performed between the first device and the second device may involve a control message such as an RCM (e.g., 206) being sent from the first device (as a controller) to the second device (as a controlee) during an initial discovery and configuration stage. The control message may include metadata including an identifier that indicates whether the first and second devices are compatible devices that may be part of the same ecosystem of devices. During the discovery stage, another protocol outside of the UWB may be used, or UWB may be used. Once discovery and configuration are complete, the first and second devices may be designated an initiator and a responder, respectively, and exchange signals and information via UWB (e.g., using RIM 212 and RRM 214). Ranging (e.g., distance) information and angle estimation may then be measured using one or more reference signals sent and received using UWB.

Means for performing functionality at block 620 may include a wireless communication interface 730 and/or other components of a UE, as illustrated in FIG. 7.

At block 630, the functionality comprises, responsive to the one or more reference signals containing metadata common to the first and second devices, estimating a distance to the second device using a radio frequency (RF) signal, estimating a relative angle with respect to the second device using an associated RF signal, or a combination thereof. In some embodiments, the metadata common to the first and second devices includes an identifier (e.g., ID) or another type of identifying information. Such identifier may be stored, coded, or present on a hardware level in each of the first device and the second device. If the identifier is the same (e.g., a reference signal received from the second device contains an identifier that is the same as that of the first device), the first device may determine that the second device is a compatible device that is part of the same ecosystem of devices. In some implementations, the metadata may contain more than one identifier that is common to the first and second devices for the first device to determine that the second device is a compatible device that is part of the same ecosystem of devices.

In some embodiments, the distance may be estimated using RF signals exchanged between the first device and the second device. In some implementations, TOF between time of arrival and time of transmission may be used to measure distance. In some embodiments, the relative angle with respect to the second device may indicate directionality with respect to the second device. The relative angle may be determined using AoA of a reference signal transmitted by an initiator device (e.g., the first device in this case) and/or transmitted by a responder device (e.g., the second device in this case). Various methodologies may be used to determine the AoA, e.g., phase-based (e.g., measuring the difference in received phase across elements of an antenna array) and/or TDOA-based (e.g., measuring the TDOA between individual elements of an antenna array).

Means for performing functionality at block 630 may include processor(s) 710, a wireless communication interface 730, and/or other components of a UE, as illustrated in FIG. 7.

At block 640, the functionality may comprise, operating the first device in a first mode of a plurality of available modes, or sending location information of the second device to a third device, based on the estimated distance to the second device, the estimated relative angle with respect to the second device, or the combination thereof.

In some embodiments, the estimated relative angle may comprise an estimated relative angle of arrival (AA) with respect to the second device, and the functionality may further comprise determining a direction of the content generated from the second device based at least on the estimated AoA.

In some embodiments, the plurality of modes may involve using different portions or components of the first device to process or otherwise respond to the content playback by the second device. For example, a particular subsystem of the first device may require waking up, if it is more power-intensive and prone to staying inactive to conserve power. A backside camera may require this particular subsystem, as it consumes more power than the frontside camera, which may be operated by a processor (e.g., digital signal processor) that is already running. Thus, in some embodiments, the operating the first device in the first mode may comprise processing the content generated from the second device using a subcomponent of the first device based on the direction of the content, and the first device may be configured to, when not operating in the first mode, operate in a second mode that does not use the subcomponent of the first device. Possibly, this subcomponent may not be used normally (e.g., because it may be relatively power-intensive), or in a low-power mode (in sleep mode, turned off, disabled, etc.). Thus, operating the first device in the first mode may involve waking up the subcomponent, and the operation in the second mode may involve usage of a second subcomponent of the first device different from the subcomponent, where the subcomponent may be configured to use more processing resources than the second subcomponent.

In addition, in some embodiments, operating the first device in the first mode may comprise using, based on the direction of the content, a first image capture device of a plurality of image capture devices of the first device, the first image capture device being more proximate to the second device than one or more other ones of the plurality of image capture devices (e.g., a smartphone having a frontside camera and a backside camera); a first audio capture device of a plurality of audio capture devices of the first device, the first audio capture device is more proximate to the second device than one or more other ones of the plurality of audio capture devices (e.g., a smartphone having a frontside microphone and a backside microphone); or a combination thereof.

In some implementations, operating the first device in the first mode may include processing the content generated from the second device using a subcomponent of the first device based on the direction of the content. As an example, according to the FIG. 4 scenario, the first device may detect the direction of content playback by the second device based at least on the directionality information (e.g., AoA). The second device may be a television generating image and/or video content, and the first device may be a smartphone whose back side is pointing toward the television. In this case, based on the direction of the content, the smartphone may use a subsystem for the backside camera rather than use the frontside camera that does not require waking up a subsystem that may be more power-intensive. If the content were coming toward the frontside of the camera, the smartphone need not have activated the subsystem for the backside camera, resulting in power savings. This way, based on context of content in the environment (e.g., direction or angle) using a low-power communication protocol such as UWB, the first device may operate more efficiently in power. In other scenarios, audio content may be processed similarly.

In some implementations, operating the first device in the first mode comprises configuring a signal, and sending the signal to the second device, the signal configured to modify a function of the second device. That is, operating the first device in the first mode may include causing the second device to operate according to a command from the first device. For example, based on the angle of an axis of the first device relative to the second device (e.g., an axis of the first device aligns with a line that connects the first and second devices within a range), the first device may send an on/off command to the second device. Consider a scenario in which a smartphone and a thermostat compatible with each other perform UWB measurements to find out that the smartphone is “pointing at” the thermostat (e.g., the thermostat intersects a vertical axis of the smartphone, within an error margin). Based on this determination, the smartphone may send a command signal to the thermostat to turn on the air. As another example, operating the first device in the first mode may result in a user interface displaying on the first device. Pointing at the thermostat may activate a control panel for the thermostat on a display of the smartphone. In some cases, the distance or range information may be a condition for triggering the thermostat control. If the smartphone is within a threshold distance, then the aforementioned operations may be performed. As another example, the first and second devices may be two smartphones, and content or data may be exchanged if the two smartphones are within a certain distance and/or angle relative to each other, which may be determined based on, e.g., UWB measurements.

In some embodiments, the functionality may further comprise obtaining one or more measurements based on image data, light, RF signals, or a combination thereof, and confirming the presence of content generated from a second device based on the one or more measurements. Here, an additional piece of information may be needed to operate in the first mode, such as visual, light, and/or RF sensing measurements to and corroborate the UWB measurements and confirm the presence of the intended source device. For instance, an image-capturing device such as a camera associated with the first device may be used to obtain image data, e.g., of at least portions of the environment surrounding the first device. The UE may recognize certain items or devices (a television, a phone, a thermostat dial, a door, etc.) within the image data using, e.g., feature extraction. If the obtained visual information confirms the content source (e.g., image contains a television, and the UWB measurements indicate that the content is coming from the television rather than another device such as a speaker), then the confidence level that the content being detected is from an intended content source may be increased.

In some embodiments, the metadata may comprise information about a type of the content generated from the second device, and the operating the first device in the first mode may comprise determining that the first device is configured to process the type of the content. Here, another additional piece of information may be needed to operate in the first mode, such information about the type of content being generated or played back. If both the content and the type of content the first device is seeking to process do not match, then the first device may not operate in the first mode. One example scenario of a mismatch may be if the first device is an earbud and the second device is displaying an image. If they do match (e.g., both are image-based, where the first device is looking for a certain item in a store or a book in a library), then UWB measurements may guide the first device toward a certain direction and/or a certain distance, and trigger further operations, e.g., display information about an item detected using an image-capturing device such as a camera.

In other embodiments, the operating the first device in the first mode may comprise sending a signal configured to control a communication interface coupled to a user, the signal configured to stimulate a sensory modality of the user according to at least the direction of the content. For example, a user-device interface such as a brain-computer interface (BCI) may be used in conjunction with UWB measurements as described elsewhere herein. The first device may be a UWB-capable device that is communicative with or embedded in electrodes attached to a user. Directionality and/or ranging information may be used to configure BCI control signals that guide the user's eyes, neck, ears, etc. in the appropriate intended direction.

In some embodiments, sending location information of the second device to a third device may include sending UWB measurements to the third device, including direction information, range or distance information, orientation information (e.g., based on IMU or gyroscopic measurements), or a combination thereof. This may be useful in cases where the first device is more powerful (larger battery, greater processing resources, etc.), so it is more suited for performing UWB measurements with the second device (e.g., content source). The first device may be a smartphone, while the third device may be a smartwatch, for example. By relaying the UWB measurements to the third device, the third device may further be able to perform operations with respect to the second device. In some example implementations, the third device may be configured to determine a direction of the second device based on the location information, and operate in the first mode based on the direction of the second device. For instance, based on the UWB measurements obtained from the smartphone, the smartwatch may activate a microphone that is closest to the content source, e.g., if the smartphone detects that the content source is within range.

### Apparatus

FIG. 7 is a block diagram of an embodiment of a UE 105, which can be utilized as described herein above (e.g., in association with FIGS. 4-6). For example, the UE 105 can perform one or more of the functions of the method shown in FIG. 6. It should be noted that FIG. 7 is meant only to provide a generalized illustration of various components, any or all of which may be utilized as appropriate. It can be noted that, in some instances, components illustrated by FIG. 7 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 7.

The UE 105 is shown comprising hardware elements that can be electrically coupled via a bus 705 (or may otherwise be in communication, as appropriate). The hardware elements may include a processor(s) 710 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 710 may comprise one or more processing units, which may be housed in a single integrated circuit (IC) or multiple ICs. As shown in FIG. 7, some embodiments may have a separate DSP 720, depending on desired functionality. Location determination and/or other determinations based on wireless communication may be provided in the processor(s) 710 and/or wireless communication interface 730 (discussed below). The UE 105 also can include one or more input devices 770, which can include without limitation one or more keyboards, touch screens, touch pads, microphones, buttons, dials, switches, and/or the like; and one or more output devices 715, which can include without limitation one or more displays (e.g., touch screens), light emitting diodes (LEDs), speakers, and/or the like.

The UE 105 may also include a wireless communication interface 730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 730 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 732 that send and/or receive wireless signals 734. According to some embodiments, the wireless communication antenna(s) 732 may comprise a plurality of discrete antennas, antenna arrays, or any combination thereof. The antenna(s) 732 may be capable of transmitting and receiving wireless signals using beams (e.g., Tx beams and Rx beams). Beam formation may be performed using digital and/or analog beam formation techniques, with respective digital and/or analog circuitry. The wireless communication interface 730 may include such circuitry.

Depending on desired functionality, the wireless communication interface 730 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN. The wireless communication interface 730 and the wireless communication antenna(s) 732 may be capable of UWB communication.

The UE 105 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 780 capable of receiving signals 784 from one or more GNSS satellites using an antenna 782 (which could be the same as antenna 732). Positioning based on GNSS signal measurement can be utilized to complement and/or incorporate the techniques described herein. The GNSS receiver 780 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 780 is illustrated in FIG. 7 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 710, DSP 720, and/or a processor within the wireless communication interface 730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 710 or DSP 720.

The UE 105 may further include and/or be in communication with a memory 760. The memory 760 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 of the UE 105 also can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the UE 105 (and/or processor(s) 710 or DSP 720 within UE 105). In some embodiments, then, such code and/or instructions can be used to configure and/or adapt a general-purpose computer (or other device) to perform one or more operations in accordance with the described methods.

FIG. 8 is a block diagram of an embodiment of a computer system 800, which may be used, in whole or in part, to provide the functions of one or more network components as described in the embodiments herein, particularly close-range application such as IoT and D2D communications. A content source such as 402 may be an example of the computer system 800. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner. In addition, it can be noted that components illustrated by FIG. 8 can be localized to a single device and/or distributed among various networked devices, which may be disposed at different geographical locations.

The computer system 800 is shown comprising hardware elements that can be electrically coupled via a bus 805 (or may otherwise be in communication, as appropriate). The hardware elements may include processor(s) 810, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 800 also may comprise one or more input devices 815, which may comprise without limitation a mouse, a keyboard, a camera, a microphone, and/or the like; and one or more output devices 820, which may comprise without limitation a display device, a printer, and/or the like.

The computer system 800 may further include (and/or be in communication with) one or more non-transitory storage devices 825, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 800 may also include a communications subsystem 830, which may comprise wireless communication technologies managed and controlled by a wireless communication interface 833, a UWB communications interface 834, as well as wired technologies (such as Ethernet, coaxial communications, universal serial bus (USB), and the like). The wireless communication interface 833 may comprise one or more wireless transceivers that may send and receive wireless signals 855 (e.g., signals according to 5G NR or LTE) via wireless antenna(s) 850. The UWB communications interface 834 may be coupled to the wireless antenna(s) 850 to send signals and data in the UWB (e.g., over about 499.2 MHZ). Thus the communications subsystem 830 may comprise a modem, a network card (wireless or wired), an infrared communication device, a wireless communication device, and/or a chipset, and/or the like, which may enable the computer system 800 to communicate on any or all of the communication networks described herein to any device on the respective network, including a User Equipment (UE), base stations and/or other TRPs, and/or any other electronic devices described herein. Hence, the communications subsystem 830 may be used to receive and send data as described in the embodiments herein.

In many embodiments, the computer system 800 will further comprise a working memory 835, which may comprise a RAM or ROM device, as described above. Software elements, shown as being located within the working memory 835, may comprise an operating system 840, device drivers, executable libraries, and/or other code, such as one or more applications 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 825 described above. In some cases, the storage medium might be incorporated within a computer system, such as computer system 800. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of operating a device of a group of proximate devices, the method comprising: detecting, using one or more sensors or transceivers of a first device, a presence of content playback by a second device; receiving, at the first device, one or more reference signals from the second device; responsive to the one or more reference signals containing metadata common to the first and second devices, estimating a distance to the second device using a radio frequency (RF) signal, estimating a relative angle with respect to the second device using an associated RF signal, or a combination thereof; and operating the first device in a first mode of a plurality of available modes, or sending location information of the second device to a third device, based on the estimated distance to the second device, the estimated relative angle with respect to the second device, or the combination thereof.
Clause 2. The method of clause 1, wherein: the estimated relative angle comprises an estimated angle of arrival (AoA) with respect to the second device; and the method further comprises determining a direction of the content generated from the second device based at least on the estimated AoA.
Clause 3. The method of any one of clauses 1-2 wherein operating the first device in the first mode comprises processing the content generated from the second device using a first subcomponent of the first device based on the direction of the content; and the first device is configured to, when not operating in the first mode, operate in a second mode that does not use the first subcomponent of the first device.
Clause 4. The method of any one of clauses 1-3 wherein operating the first device in the first mode comprises waking up the first subcomponent, and the operation in the second mode comprises usage of a second subcomponent of the first device different from the first subcomponent; and the first subcomponent is configured to use more processing resources than the second subcomponent.
Clause 5. The method of any one of clauses 1-4 wherein, based on the direction of the content, operating the first device in the first mode comprises using a first image capture device of a plurality of image capture devices of the first device, the first image capture device being more proximate to the second device than other image capture devices of the plurality of image capture devices; a first audio capture device of a plurality of audio capture devices of the first device, the first audio capture device is more proximate to the second device than other audio capture devices of the plurality of audio capture devices; or a combination thereof.
Clause 6. The method of any one of clauses 1-5 wherein operating the first device in the first mode comprises sending a signal to the second device, the signal configured to modify a function of the second device.
Clause 7. The method of any one of clauses 1-6 wherein operating the first device in the first mode comprises sending a signal configured to control a communication interface coupled to a user, the signal configured to stimulate a sensory modality of the user according to at least the direction of the content.
Clause 8. The method of any one of clauses 1-7 wherein the content comprises image content, audio content, video content, radio frequency (RF) signals, or a combination thereof.
Clause 9. The method of any one of clauses 1-8 further comprising performing, at the first device, a discovery process with the second device based on the metadata; wherein receiving the one or more reference signals from the second device comprises receiving the one or more reference signals via ultra-wideband (UWB) subsequent to completion of the discovery process.
Clause 10. The method of any one of clauses 1-9 wherein the third device is configured to: determine a direction of the second device based on the location information; and operate in the first mode based on the direction of the second device.
Clause 11. The method of any one of clauses 1-10 further comprising obtaining one or more measurements based on image data, light, radio frequency (RF) signals, or a combination thereof; and confirming the presence of content generated from a second device based on the one or more measurements.
Clause 12. The method of any one of clauses 1-11 wherein the metadata comprises information about a type of the content generated from the second device; and operating the first device in the first mode comprises determining that the first device is configured to process the type of the content.
Clause 13. The method of any one of clauses 1-12 further comprising terminating the estimating the distance, the estimating the relative angle, or the combination thereof.
Clause 14. A wireless device within a wireless network, the wireless device comprising: one or more transceivers configured to communicate with another wireless device over ultra-wideband (UWB); memory; and one or more processors communicatively coupled to the one or more transceivers and the memory, and configured to: detect, using one or more sensors or transceivers of a first device, a presence of content playback by a second device; receive, at the first device, one or more reference signals from the second device; responsive to the one or more reference signals containing metadata common to the first and second devices, estimate a distance to the second device using a radio frequency (RF) signal, estimate a relative angle with respect to the second device using an associated RF signal, or a combination thereof, and operate the first device in a first mode of a plurality of available modes, or send location information of the second device to a third device, based on the estimated distance to the second device, the estimated relative angle with respect to the second device, or the combination thereof.
Clause 15. The wireless device of clause 14, wherein: the estimated relative angle comprises an estimated angle of arrival (AoA) with respect to the second device; and the one or more processors are further configured to determine a direction of the content generated from the second device based at least on the estimated AoA.
Clause 16. The wireless device of any one of clauses 14-15 wherein operation of the first device in the first mode comprises processing the content generated from the second device using a first subcomponent of the first device based on the direction of the content; and the first device is configured to, when not operating in the first mode, operate in a second mode that does not use the first subcomponent of the first device.
Clause 17. The wireless device of any one of clauses 14-16 wherein operation of the first device in the first mode comprises waking up the first subcomponent, and the operation in the second mode comprises usage of a second subcomponent of the first device different from the first subcomponent; and the first subcomponent is configured to use more processing resources than the second subcomponent.
Clause 18. The wireless device of any one of clauses 14-17 wherein the one or more processors are further configured to operate the first device in the second mode responsive to the one or more reference signals not containing metadata common to the first and second devices, or responsive to the metadata indicating that a type of the first device and a type of the second device do not match.
Clause 19. The wireless device of any one of clauses 14-18 wherein, based on the direction of the content, operation of the first device in the first mode comprises using a first image capture device of a plurality of image capture devices of the first device, the first image capture device being more proximate to the second device than other image capture devices of the plurality of image capture devices; a first audio capture device of a plurality of audio capture devices of the first device, the first audio capture device is more proximate to the second device than other audio capture devices of the plurality of audio capture devices; or a combination thereof.
Clause 20. The wireless device of any one of clauses 14-19 wherein the third device is configured to: determine a direction of the second device based on the location information; and operate in the first mode based on the direction of the second device.
Clause 21. The wireless device of any one of clauses 14-20 wherein the metadata comprises information about a type of the content generated from the second device; and operation of the first device in the first mode comprises determination that the first device is configured to process the type of the content.
Clause 22. The wireless device of any one of clauses 14-21 wherein the one or more processors are further configured to terminate the estimation of the distance, the estimation of the relative angle, or the combination thereof.
Clause 23. A non-transitory computer-readable apparatus comprising a storage medium, the storage medium comprising a plurality of instructions configured to, when executed by one or more processors, cause a computerized apparatus to: detect, using one or more sensors or transceivers of a first device, a presence of content playback by a second device; receive, at the first device, one or more reference signals from the second device; responsive to the one or more reference signals containing metadata common to the first and second devices, estimate a distance to the second device using a radio frequency (RF) signal, estimate a relative angle with respect to the second device using an associated RF signal, or a combination thereof; and operate the first device in a first mode of a plurality of available modes, or send location information of the second device to a third device, based on the estimated distance to the second device, the estimated relative angle with respect to the second device, or the combination thereof.
Clause 24. The non-transitory computer-readable apparatus of clause 23, wherein:
the estimated relative angle comprises an estimated angle of arrival (AoA) with respect to the second device; and the plurality of instructions are further configured to, when executed by the one or more processors, cause the computerized apparatus to determine a direction of the content generated from the second device based at least on the estimated AoA.
Clause 25. The non-transitory computer-readable apparatus of any one of clauses 23-24 wherein operation of the first device in the first mode comprises processing the content generated from the second device using a first subcomponent of the first device based on the direction of the content; and the first device is configured to, when not operating in the first mode, operate in a second mode that does not use the first subcomponent of the first device.
Clause 26. The non-transitory computer-readable apparatus of any one of clauses 23-25 wherein the metadata comprises information about a type of the content generated from the second device; and operation of the first device in the first mode comprises determination that the first device is configured to process the type of the content.
Clause 27. An apparatus comprising: means for detecting, using one or more sensors or transceivers of a first device, a presence of content playback by a second device; means for receiving, at the first device, one or more reference signals from the second device; means for, responsive to the one or more reference signals containing metadata common to the first and second devices, estimating a distance to the second device using a radio frequency (RF) signal, estimating a relative angle with respect to the second device using an associated RF signal, or a combination thereof; and means for operating the first device in a first mode of a plurality of available modes, or sending location information of the second device to a third device, based on the estimated distance to the second device, the estimated relative angle with respect to the second device, or the combination thereof.
Clause 28. The apparatus of clause 27, wherein: the estimated relative angle comprises an estimated angle of arrival (AoA) with respect to the second device; and the apparatus further comprises means for determining a direction of the content generated from the second device based at least on the estimated AoA.
Clause 29. The apparatus of any one of clauses 27-28 wherein the means for operating the first device in the first mode comprises means for processing the content generated from the second device using a first subcomponent of the first device based on the direction of the content; and the first device is configured to, when not operating in the first mode, operate in a second mode that does not use the first subcomponent of the first device.
Clause 30. The apparatus of any one of clauses 27-29 wherein the metadata comprises information about a type of the content generated from the second device; and operation of the first device in the first mode comprises determination that the first device is configured to process the type of the content.

1. A method of operating a device of a group of proximate devices, the method comprising:
detecting, using one or more sensors or transceivers of a first device, a presence of content playback by a second device;
receiving, at the first device, one or more reference signals from the second device;
responsive to the one or more reference signals containing metadata common to the first and second devices, estimating a distance to the second device using a radio frequency (RF) signal, estimating a relative angle with respect to the second device using an associated RF signal, or a combination thereof; and
operating the first device in a first mode of a plurality of available modes, or sending location information of the second device to a third device, based on the estimated distance to the second device, the estimated relative angle with respect to the second device, or the combination thereof.

2. The method of claim 1, wherein:
the estimated relative angle comprises an estimated angle of arrival (AoA) with respect to the second device; and
the method further comprises determining a direction of the content generated from the second device based at least on the estimated AoA.

3. The method of claim 2, wherein:
operating the first device in the first mode comprises processing the content generated from the second device using a first subcomponent of the first device based on the direction of the content; and
the first device is configured to, when not operating in the first mode, operate in a second mode that does not use the first subcomponent of the first device.

4. The method of claim 3, wherein:
operating the first device in the first mode comprises waking up the first subcomponent, and the operation in the second mode comprises usage of a second subcomponent of the first device different from the first subcomponent; and
the first subcomponent is configured to use more processing resources than the second subcomponent.

5. The method of claim 2, wherein, based on the direction of the content, operating the first device in the first mode comprises using:
a first image capture device of a plurality of image capture devices of the first device, the first image capture device being more proximate to the second device than other image capture devices of the plurality of image capture devices;
a first audio capture device of a plurality of audio capture devices of the first device, the first audio capture device is more proximate to the second device than other audio capture devices of the plurality of audio capture devices; or
a combination thereof.

6. The method of claim 2, wherein operating the first device in the first mode comprises sending a signal to the second device, the signal configured to modify a function of the second device.

7. The method of claim 2, wherein operating the first device in the first mode comprises sending a signal configured to control a communication interface coupled to a user, the signal configured to stimulate a sensory modality of the user according to at least the direction of the content.

8. The method of claim 1, wherein the content comprises image content, audio content, video content, radio frequency (RF) signals, or a combination thereof.

9. The method of claim 1, further comprising:
performing, at the first device, a discovery process with the second device based on the metadata;
wherein receiving the one or more reference signals from the second device comprises receiving the one or more reference signals via ultra-wideband (UWB) subsequent to completion of the discovery process.

10. The method of claim 1, wherein the third device is configured to:
determine a direction of the second device based on the location information; and
operate in the first mode based on the direction of the second device.

11. The method of claim 1, further comprising:
obtaining one or more measurements based on image data, light, radio frequency (RF) signals, or a combination thereof; and
confirming the presence of content generated from a second device based on the one or more measurements.

12-13. (canceled)

14. A wireless device within a wireless network, the wireless device comprising:
one or more transceivers configured to communicate with another wireless device over ultra-wideband (UWB);
memory; and
one or more processors communicatively coupled to the one or more transceivers and the memory, and configured to:
detect, using one or more sensors or transceivers of a first device, a presence of content playback by a second device;
receive, at the first device, one or more reference signals from the second device;
responsive to the one or more reference signals containing metadata common to the first and second devices, estimate a distance to the second device using a radio frequency (RF) signal, estimate a relative angle with respect to the second device using an associated RF signal, or a combination thereof; and
operate the first device in a first mode of a plurality of available modes, or send location information of the second device to a third device, based on the estimated distance to the second device, the estimated relative angle with respect to the second device, or the combination thereof.

15. The wireless device of claim 14, wherein:
the estimated relative angle comprises an estimated angle of arrival (AoA) with respect to the second device; and
the one or more processors are further configured to determine a direction of the content generated from the second device based at least on the estimated AoA.

16. The wireless device of claim 15, wherein:
operation of the first device in the first mode comprises processing the content generated from the second device using a first subcomponent of the first device based on the direction of the content; and
the first device is configured to, when not operating in the first mode, operate in a second mode that does not use the first subcomponent of the first device.

17. The wireless device of claim 16, wherein:
operation of the first device in the first mode comprises waking up the first subcomponent, and the operation in the second mode comprises usage of a second subcomponent of the first device different from the first subcomponent; and
the first subcomponent is configured to use more processing resources than the second subcomponent.

18. (canceled)

19. The wireless device of claim 15, wherein, based on the direction of the content, operation of the first device in the first mode comprises using:
a first image capture device of a plurality of image capture devices of the first device, the first image capture device being more proximate to the second device than other image capture devices of the plurality of image capture devices;
a first audio capture device of a plurality of audio capture devices of the first device, the first audio capture device is more proximate to the second device than other audio capture devices of the plurality of audio capture devices; or
a combination thereof.

20. (canceled)

21. The wireless device of claim 15, wherein:
the metadata comprises information about a type of the content generated from the second device; and
operation of the first device in the first mode comprises determination that the first device is configured to process the type of the content.

22. (canceled)

23. A non-transitory computer-readable apparatus comprising a storage medium, the storage medium comprising a plurality of instructions configured to, when executed by one or more processors, cause a computerized apparatus to:
detect, using one or more sensors or transceivers of a first device, a presence of content playback by a second device;
receive, at the first device, one or more reference signals from the second device;
responsive to the one or more reference signals containing metadata common to the first and second devices, estimate a distance to the second device using a radio frequency (RF) signal, estimate a relative angle with respect to the second device using an associated RF signal, or a combination thereof, and
operate the first device in a first mode of a plurality of available modes, or send location information of the second device to a third device, based on the estimated distance to the second device, the estimated relative angle with respect to the second device, or the combination thereof.

24. The non-transitory computer-readable apparatus of claim 23, wherein: the estimated relative angle comprises an estimated angle of arrival (AoA) with respect to the second device; and
the plurality of instructions are further configured to, when executed by the one or more processors, cause the computerized apparatus to determine a direction of the content generated from the second device based at least on the estimated AoA.

25. The non-transitory computer-readable apparatus of claim 24, wherein:
operation of the first device in the first mode comprises processing the content generated from the second device using a first subcomponent of the first device based on the direction of the content; and
the first device is configured to, when not operating in the first mode, operate in a second mode that does not use the first subcomponent of the first device.

26-30. (canceled)
